(19) United States
(12) Patent Application Publication
(10) Pub. No.: US 2026/0163082 A1
(43) Pub. Date: Jun. 11, 2026

(54) BATTERY MANAGEMENT DEVICE

(71) Applicants: TOYOTA JIDOSHA KABUSHIKI KAISHA, Toyota-shi (JP); KABUSHIKI KAISHA TOYOTA CHUO KENKYUSHO, Nagakute-shi (JP)

(72) Inventors: Ryo MANO, Nisshin-shi (JP); Yoshiaki KIKUCHI, Toyota-shi (JP); Yuji NISHI, Nagoya-shi (JP); Hiroki TASHIRO, Nisshin-shi (JP); Keisuke ISHIKAWA, Nagakute-shi (JP)

(73) Assignees: TOYOTA JIDOSHA KABUSHIKI KAISHA, Toyota-shi (JP); KABUSHIKI KAISHA TOYOTA CHUO KENKYUSHO, Nagakute-shi (JP)

(21) Appl. No.: 19/392,886

(22) Filed: Nov. 18, 2025

(30) Foreign Application Priority Data
Dec. 6, 2024 (JP) 2024-213216

(51) Int. Cl. H01M 10/42; H01M 10/0525

(52) U.S. Cl. CPC H01M 10/425; H01M 10/0525; H01M 2010/4271

(57) ABSTRACT

A battery management device according to the present disclosure includes a high-frequency signal supplying unit applying a high-frequency signal with a frequency of 0.1 MHz or higher to a lithium-ion secondary battery, a storage unit storing a real part of alternating current impedance of the lithium-ion secondary battery to which the high frequency signal is applied at a first point in time, as a reference value for each battery temperature, an impedance detecting unit detecting the real part of the alternating current impedance of the lithium ion secondary battery to which the high frequency signal is applied at a second point in time after the first point in time, at a certain battery temperature, and a determining unit determining whether there is deposition of lithium in the lithium ion secondary battery, based on the real part of the alternating current impedance detected and the reference value at the battery temperature.

### CROSS-REFERENCE TO RELATED APPLICATION

This application claims priority to Japanese Patent Application No. 2024-213216 filed on Dec. 6, 2024. The disclosure of the above-identified application, including the specification, drawings, and claims, is incorporated by reference herein in its entirety.

### BACKGROUND

### 1. Technical Field

The present disclosure relates to a battery management device.

### 2. Description of Related Art

There is demand to suppress deposition of metallic lithium (Li) (hereinafter, Li deposition) in lithium-ion secondary batteries, in order to suppress deterioration of performance of lithium-ion secondary batteries. However, no non-destructive method for detecting Li deposition in lithium-ion secondary batteries has been known.

In response to this, the present inventors developed a technique for detecting a real part of alternating current impedance of a lithium-ion secondary battery using high-frequency signals, and calculating an amount of Li deposition in the lithium-ion secondary battery based on difference between a current value and an initial value of the real part of the alternating current impedance, as disclosed in Japanese Unexamined Patent Application Publication No. 2022-108602 (JP 2022-108602 A).

### SUMMARY

Now, Li deposition advances more the greater the charging power is, and accordingly an allowable charging power is set for each type of lithium-ion secondary battery, from the perspective of suppressing Li deposition. Here, the rate of advance of Li deposition in lithium-ion secondary batteries varies (e.g., standard deviation σ) among individual products, even for the same type of battery. In conventional lithium-ion secondary batteries, for example in products within a range of ±6σ, the allowable charging power for each type was set (fixed) excessively low so as to suppress Li deposition from advancing, resulting in a problem of long charging times.

Accordingly, the present inventors developed a technique of reducing the allowable charging power in accordance with the amount of Li deposition that is calculated using the technique that is disclosed in JP 2022-108602 A. According to this technique, in a product within a range of ±3σ, for example, the allowable charging power at the start of use can be set high to a level at which Li deposition does not advance, and the charging time can also be shortened. In the technique developed by the present inventors, further improvement of detection accuracy of Li deposition is desired.

The present disclosure has been made in light of the above circumstances, and an object thereof is to provide a battery management device that can improve detection accuracy of Li deposition.

A battery management device according to the present disclosure includes a high-frequency signal supplying unit that applies a high-frequency signal with a frequency of 0.1 MHz or higher to a lithium-ion secondary battery, a storage unit that stores a real part of an alternating current impedance of the lithium-ion secondary battery to which the high-frequency signal is applied at a first point in time, as a reference value for each battery temperature, an impedance detecting unit that detects the real part of the alternating current impedance of the lithium-ion secondary battery to which the high-frequency signal is applied at a second point in time after the first point in time, at a certain battery temperature, and a determining unit that determines whether there is deposition of lithium in the lithium-ion secondary battery, based on the real part of the alternating current impedance that is detected and the reference value at the battery temperature.

The present disclosure enables a battery management device that is capable of improving detection accuracy of Li deposition to be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration example of a battery management system according to the present disclosure;

FIG. 2 is a diagram showing a relation between state of health (SOH) of a secondary battery and an amount of change in a real part Z of alternating current impedance when a high-frequency signal of 1 MHz is supplied to the secondary battery;

FIG. 3 is a diagram showing a relation between frequency of alternating current signals that are supplied to a secondary battery and the real part of the alternating current impedance that is detected from the secondary battery;

FIG. 4 is a diagram showing a relation between the frequency of the alternating current signals that are supplied to the secondary battery and the real part of the alternating current impedance that is detected from the secondary battery; and

FIG. 5 is a flowchart showing operations of a battery management device according to the present disclosure.

### DETAILED DESCRIPTION OF EMBODIMENTS

A specific embodiment to which the present disclosure is applied will be described in detail below with reference to the drawings. Note, however, that the present disclosure is not limited to the following embodiments. Also, the following description and drawings are simplified as appropriate for clarity of description.

### First Embodiment

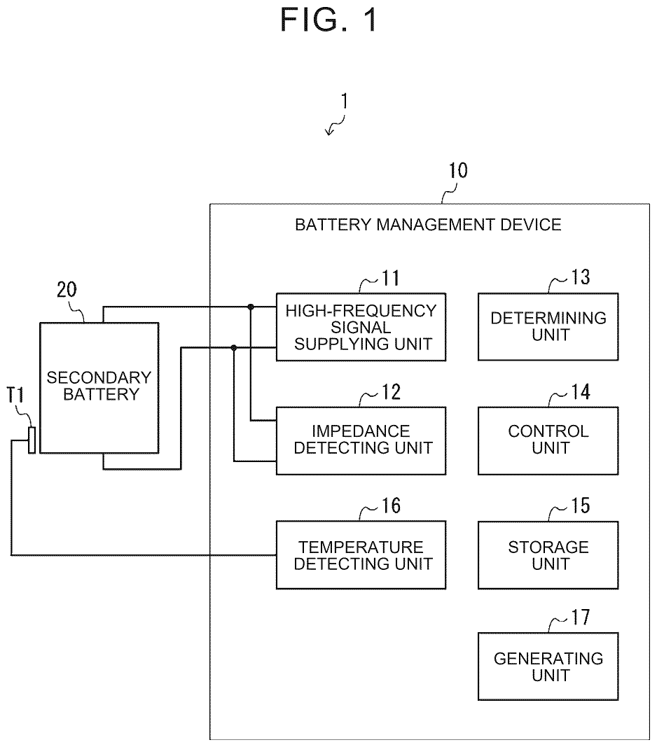

FIG. 1 is a block diagram illustrating a configuration example of a battery management system 1 according to a first embodiment. As illustrated in FIG. 1, the battery management system 1 includes a battery management device 10 and a secondary battery 20 that is managed by the battery management device 10.

The secondary battery 20 is a lithium-ion secondary battery, and is configured including a cell stack made up of a plurality of stacked battery cells, and a case that houses the cell stack.

Each of the battery cells includes a cathode, an anode, and an ionic transmission medium that is disposed between the cathode and the anode, and that conducts carrier ions. A separator may further be provided between the cathode and the anode. The separator is made of a resin such as polyethylene, polypropylene, or the like.

For a cathode active material, for example, a sulfide containing a transition metal element, an oxide containing lithium and a transition metal element, or the like, are used. Specifically, for the cathode active material, lithium manganese composite oxides with a basic composition formula such as Li₍₁₋ₓ₎MnO₂ (where 0<x<1), Li₍₁₋ₓ₎Mn₂O₄, or the like, lithium cobalt composite oxides with a basic composition formula such as Li₍₁₋ₓ₎CoO₂ or the like, lithium nickel composite oxides with a basic composition formula such as Li₍₁₋ₓ₎NiO₂, or the like, or lithium nickel cobalt manganese composite oxides with a basic composition formula such as Li₍₁₋ₓ₎NiₐCo_{b}Mn_{c}O₂ (where a+b+c=1), or the like, are used. Note that for the cathode active material, a substance may be used that includes the above basic composition formula containing other elements. Aluminum (Al) or the like, for example, is used for a current collector of the cathode

For an anode active material, for example, a composite oxide containing lithium, a carbon material, or the like, is used. Specifically, for the anode active material an inorganic compound such as lithium, lithium alloys, tin compounds, or the like, a carbon material that is capable of absorbing and releasing lithium ions, a composite oxide containing a plurality of elements, a conductive polymer, and so forth, are used. Examples of carbon materials that are used for the anode active material include cokes, glassy carbons, graphites, non-graphitizable carbons, pyrolytic carbons, carbon fibers, and so forth, with graphites, such as artificial graphite, natural graphite, and so forth being preferred. Also, examples of the composite oxide that is used for the anode active material include lithium titanium composite oxides, lithium vanadium composite oxides, and so forth. Copper (Cu) or the like, for example, is used for an anode current collector.

An ionically conductive medium is used as an electrolytic solution, by dissolving a supporting salt, for example. For the supporting salt, for example, a lithium salt such as LiPF₆, LiBF₄, or the like, is used. For a solvent for the electrolytic solution, for example, any one of carbonates, esters, ethers, nitriles, furans, sulfolanes, and dioxolanes, or a mixture of several of these, is used. Examples of carbonates include cyclic carbonates such as ethylene carbonate, propylene carbonate, vinylene carbonate, butylene carbonate, chloroethylene carbonate, and so forth, and chain carbonates such as dimethyl carbonate, ethyl methyl carbonate, diethyl carbonate, ethyl-n-butyl carbonate, methyl-t-butyl carbonate, di-i-propyl carbonate, t-butyl-i-propyl carbonate, and so forth. Alternatively, for the ionically conductive medium, a solid ionically conductive polymer, an inorganic solid electrolyte, a mixed material of an organic polymer electrolyte and an inorganic solid electrolyte, an inorganic solid powder that is bound by an organic binder, or the like, may be used.

The battery management device 10 performs charging management of the secondary battery 20 that is to be managed. For example, the battery management device 10 non-destructively detects presence or absence of Li deposition in the secondary battery 20, and performs feedback control of the allowable charging power (upper limit of charging power) Pa for the secondary battery 20, based on results of the detection.

The battery management device 10 includes a high-frequency signal supplying unit 11, an impedance detecting unit 12, a determining unit 13, a control unit 14, a storage unit 15, a temperature detecting unit 16, and a generating unit 17.

The high-frequency signal supplying unit 11 supplies high-frequency signals to the secondary battery 20. The impedance detecting unit 12 detects a value of a real part Z of the alternating current impedance from the secondary battery 20 to which the high-frequency signals are supplied.

Now, in the secondary battery 20, metallic Li is deposited on electrode surfaces of the battery cells as a result of repeated charging. Li deposition advances more the greater the charging power is in order to increase the charging speed, and causes the state of health (SOH) of the secondary battery 20 to deteriorate. Note that the SOH of the secondary battery 20 refers to the percentage of the current capacity of the secondary battery 20, with the initial capacity thereof as 100%. Accordingly, it is desirable to set the secondary battery 20 to the highest possible allowable charging power Pa that allows efficient charging in the shortest possible charging time, while suppressing Li deposition.

Now, when an alternating current signal (high-frequency signal), of such a high frequency that diffusion, reaction, and movement of lithium ions in each of the battery cells of the secondary battery 20 cannot keep up, is supplied to the secondary battery 20, the current of the high-frequency signal flows along edges of conductors in each of the battery cells due to the skin effect. In other words, the current of the high-frequency signal flows over electrode surfaces of each of the battery cells, where Li is readily deposited, due to the skin effect. Also, even when the Li metal is electrically disconnected from the anode after Li deposition, and is in a floating state, a current still flows over the Li metal due to inductive coupling and capacitive coupling. Accordingly, when no Li has been deposited from the initial state, the value of the real part Z of the alternating current impedance does not change, and the more the amount of Li deposition is, the higher the electrical conductivity of the electrode surface of each of the battery cells becomes, and thus the smaller the value of the real part Z of the alternating current impedance becomes. Now, a great current is concentrated on the Li metal, which has high electrical conductivity, and accordingly a magnetic field changes around Li deposition regions, which is accompanied by generation of eddy currents. Such eddy currents cause loss in conductive portions of current collecting foils and electrodes, but reduce loss in the battery as a whole. Accordingly, the greater the amount of Li deposition is, the greater the change in the magnetic field is, and accordingly the greater the eddy currents become, so the smaller the value of the real part Z will be. Hence, it is possible to calculate the amount of Li deposition in the secondary battery 20 from the value of the real part Z of the alternating current impedance that is detected from the secondary battery 20 to which the high-frequency signals are supplied. Once the amount of Li deposition is known, the SOH of the secondary battery 20 can also be estimated.

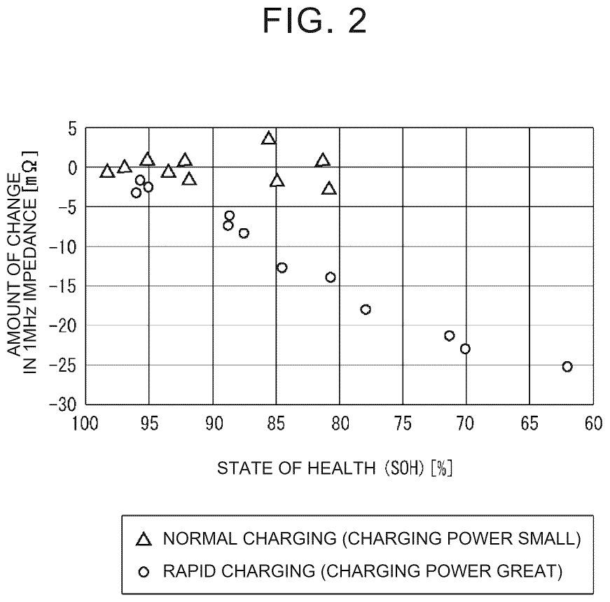

FIG. 2 is a diagram showing a relation between SOH of the secondary battery 20 and the amount of change in the real part Z of the alternating current impedance (difference between detected value and initial value) when a high-frequency signal of 1 MHz is supplied to the secondary battery 20. As indicated by triangle marks in FIG. 2, in the case of normal charging with a small charging power, the amount of Li deposition is small even when charging is repeated, and accordingly the amount of change in the real part Z of the alternating current impedance remains small even when deterioration of the SOH advances due to some other factor (i.e., the detected value of the real part Z of the alternating current impedance is maintained at a high value). In contrast, as indicated by circle marks in FIG. 2, in the case of rapid charging with a great charging power, the amount of Li deposition increases with repeated charging, and accordingly, the deterioration of the SOH advances and the amount of change in the real part Z of the alternating current impedance becomes great (i.e., the detected value of the real part Z of the alternating current impedance becomes low). Note that when Li deposition is predominant among causes of the battery deterioration, the amount of Li deposition can be derived from the SOH. Alternatively, the SOH can be derived from the amount of Li deposited.

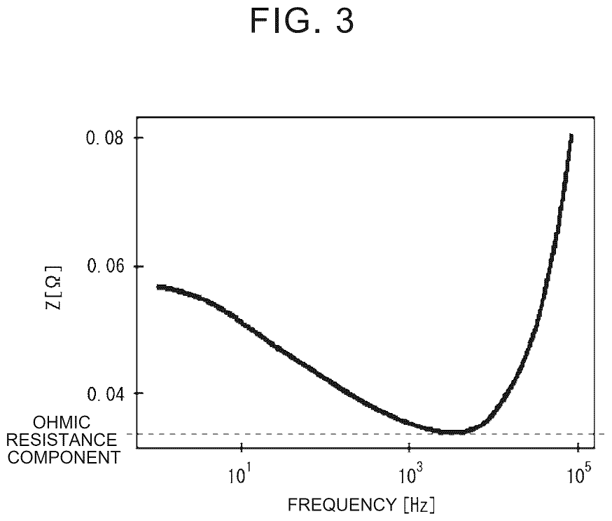

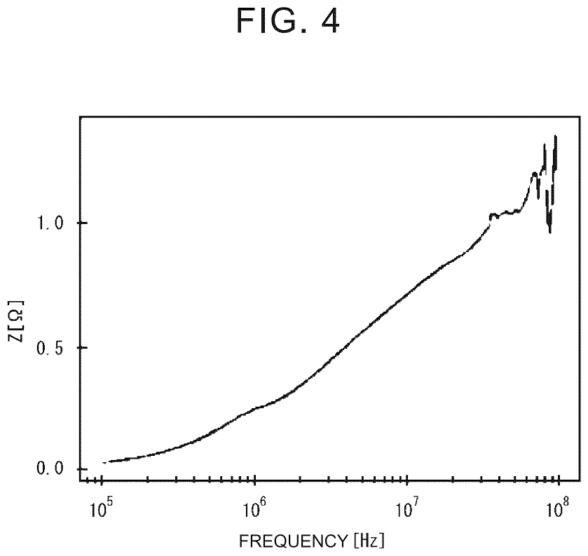

FIGS. 3 and 4 are diagrams showing a relation between frequency of alternating current signals that are supplied to the secondary battery 20 and the real part of the alternating current impedance that is detected from the secondary battery 20. FIG. 3 shows the value of the real part Z of the alternating current impedance when alternating current signals ranging from 1 kHz to 100 kHz are supplied to the secondary battery 20. FIG. 4 shows the value of the real part Z of the alternating current impedance when alternating current signals ranging from 100 kHz to 100 MHz are supplied to the secondary battery 20.

As shown in FIG. 3, when an alternating current signal of around 1 kHz is supplied to the secondary battery 20, the value of the real part Z of the alternating current impedance indicates a minimum value. An impedance component at this time represents an ohmic resistance component. Also, as shown in FIGS. 3 and 4, as the frequency of the alternating current signal that is supplied to the secondary battery 20 increases, the skin effect causes the current flow to concentrate on the electrode surface of each of the cells, and accordingly the value of the real part Z of the alternating current impedance increases.

Accordingly, the high-frequency signal supplying unit 11 supplies the secondary battery 20 with an alternating current signal (i.e., high-frequency signal) having such a high frequency that the value of the real part Z of the alternating current impedance, which is sufficiently high as compared to the ohmic resistance component, can be detected. For example, the high-frequency signal supplying unit 11 supplies a high-frequency signal of 0.1 MHz or higher to the secondary battery 20. In the examples in FIGS. 3 and 4, the high-frequency signal supplying unit 11 supplies the secondary battery 20 with a high-frequency signal of 0.5 MHz or higher. As a result, the current of the high-frequency signal flows over the electrode surface (Li deposition region) of each of the battery cells of the secondary battery 20, due to the skin effect. This allows the impedance detecting unit 12 to detect the real part Z of the alternating current impedance in accordance with the amount of Li deposition.

The temperature detecting unit 16 detects a battery temperature of the secondary battery 20. For example, the temperature detecting unit 16 detects the battery temperature of one or more battery cells out of the battery cells making up the secondary battery 20 using one or more thermistors T1. The temperature detecting unit 16 may calculate the resistance value of each of the battery cells, from cell voltage of each of the battery cells. The temperature detecting unit 16 may then calculate difference in heat generation amount of each of the battery cells and the heat generation amount of the battery cell to which the thermistor T1 is attached, from difference between the resistance value that is calculated for each of the battery cells and the resistance value of the battery cell to which the thermistor T1 is attached, and estimate the temperature of each of the battery cells from the calculation results.

The storage unit 15 stores information regarding a reference value of the real part Z of the alternating current impedance of the secondary battery 20, for each battery temperature. The value of the real part Z of the alternating current impedance of the secondary battery 20 is measured at a certain point in time (referred to as a first point in time) for a plurality of battery temperatures, and the measurement results are stored in the storage unit 15 as reference values. The reference values may be measured in advance before the secondary battery 20 starts to operate, or may be measured while the secondary battery 20 is in operation.

The battery management device 10 may include the generating unit 17 that generates information indicating a reference value for each battery temperature. The generating unit 17 may, for example, monitor the battery temperature that is detected by the temperature detecting unit 16, and when a new battery temperature is detected, generate information indicating a reference value for each battery temperature by acquiring the real part Z of the alternating current impedance that is detected at that time.

For example, when the secondary battery 20 is an on-board battery that is installed in a vehicle, the battery temperature of the secondary battery 20 may change depending on the state of the vehicle. The generating unit 17 can automatically collect the real part Z of the alternating current impedance of the secondary battery 20 for various battery temperatures. The real part Z of the alternating current impedance may be detected by the impedance detecting unit 12 while the vehicle is traveling or stopped.

When measuring the reference value before starting operation of the secondary battery 20, an operator, for example, may measure the real part Z of the alternating current impedance while changing the battery temperature of a new secondary battery 20, and store the measurement results in the storage unit 15 via an input interface (omitted from illustration) or the like. Alternatively, the generating unit 17 may perform control to change the battery temperature of the new secondary battery 20, while correlating the battery temperature that is detected by the temperature detecting unit 16 with the measured value of the real part Z of the alternating current impedance detected by the impedance detecting unit 12.

The determining unit 13 acquires, from the impedance detecting unit 12, the real part Z of the alternating current impedance of the secondary battery 20 to which the high-frequency signal is applied at a second point in time following the first point in time described above. The determining unit 13 then obtains the battery temperature at the second point in time above from the temperature detecting unit 16, and acquires, from the storage unit 15, the real part Z of the alternating current impedance corresponding to the battery temperature. The determining unit 13 then determines whether there is deposition of Li in the secondary battery 20, based on the difference between the reference value that is acquired from the storage unit 15 and the real part Z of the alternating current impedance that is acquired from the impedance detecting unit 12. For example, the determining unit 13 may subtract the value of the real part Z of the alternating current impedance from a reference value, and determine that there is deposition of Li in the secondary battery 20 when the subtraction result is greater than a threshold value. The determining unit 13 may perform another calculation (e.g., calculation of a ratio, etc.) other than subtraction, between the reference value and the real part Z of the alternating current impedance.

The control unit 14 controls the allowable charging power Pa for the secondary battery 20 based on the determination results from the determining unit 13. For example, when determination is made that there is no deposition of Li, the advance of Li deposition is being suppressed, and accordingly the control unit 14 controls the allowable charging power Pa to maintain the current level, or to be higher. When determination is made that there is deposition of Li, the advance of Li deposition needs to be suppressed, and accordingly the control unit 14 controls the allowable charging power Pa to be lower. Note that the control unit 14 may switch the allowable charging power Pa in stages, depending on the determination results of the presence or absence of Li deposition.

Thus, the battery management device 10 according to the present disclosure can set the highest possible allowable charging power Pa for the secondary battery 20 that enables efficient charging in the shortest possible charging time, while suppressing Li deposition. That is to say, the battery management device 10 according to the present disclosure can set the allowable charging power Pa for the secondary battery 20 to an appropriate value depending on the presence or absence of Li deposition, without being set excessively low, thereby enabling efficient charging of the secondary battery 20 to be realized.

The battery management device 10 can determine with high accuracy whether there is deposition of Li in the secondary battery 20, by using the real part Z of the alternating current impedance that is detected in the past at the same temperature, as a reference value.

### Operation of Battery Management Device 10

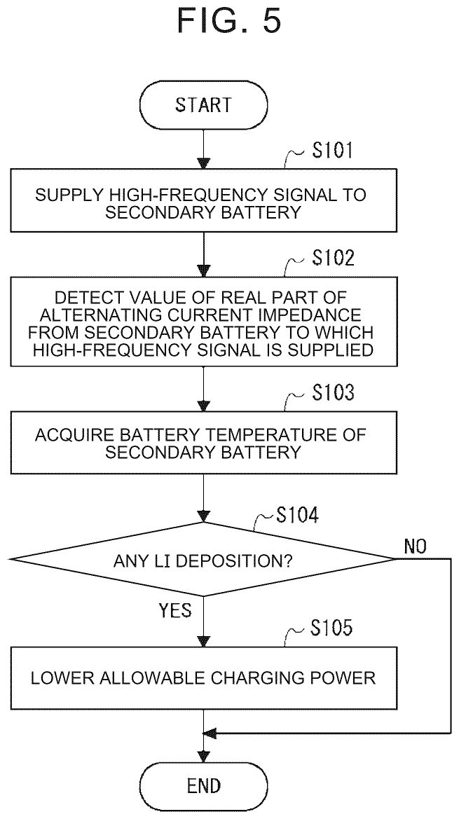

Next, an example of operations of the battery management device 10 will be described with reference to FIG. 5. FIG. 5 is a flowchart showing the operations of the battery management device 10. It will be assumed that the storage unit 15 of the battery management device 10 stores reference values of the real part Z of the alternating current impedance for each battery temperature of the secondary battery 20.

First, the battery management device 10 supplies, to the secondary battery 20, an alternating current signal (high-frequency signal) of such a high frequency that the diffusion, reaction, and movement of lithium ions in each of the battery cells cannot keep up (step S101). For example, the battery management device 10 supplies a high-frequency signal of 0.1 MHz or higher to the secondary battery 20. The battery management device 10 then detects the value of the real part Z of the alternating current impedance from the secondary battery 20 to which the high-frequency signal has been supplied (step S102).

Thereafter, the battery management device 10 acquires the battery temperature of the secondary battery 20 (step S103). Note that step S103 may be executed before step S101.

Thereafter, the battery management device 10 determines whether there is deposition of Li in the secondary battery 20, based on the reference value of the real part Z of the alternating current impedance corresponding to the battery temperature that is acquired in step S103 and the value of the real part Z of the alternating current impedance that is detected in step S102 (step S104).

When there is deposition of Li in the secondary battery 20 (YES in step S104), the battery management device 10 controls the allowable charging power Pa so as to be lowered, since the advance of Li deposition needs to be suppressed (step S105). When there is no deposition of Li in the secondary battery 20 (NO in step S104), the battery management device 10 maintains the allowable charging power Pa in the current state. Alternatively, the battery management device 10 may perform control such that the allowable charging power Pa is raised.

In this way, the battery management device 10 according to the present disclosure can set the highest possible allowable charging power Pa for the secondary battery 20 that enables efficient charging in the shortest possible charging time, while suppressing Li deposition. That is to say, the battery management device 10 according to the present disclosure can set the allowable charging power Pa for the secondary battery 20 to an appropriate value depending on the amount of Li deposition, without being set excessively low, thereby enabling efficient charging of the secondary battery 20 to be realized. The battery management device 10 can determine with high accuracy whether there is deposition of Li in the secondary battery 20, by using the real part Z of the alternating current impedance that is detected in the past at the same temperature, as a reference value.

Also, the present disclosure can be realized by causing a central processing unit (CPU) to execute a computer program for part or all of the processing of the battery management device 10.

The program that is described above includes a set of instructions (or software code) for causing the computer to perform one or more functions that are described in the embodiment when the program is loaded to the computer. The program may be stored in a non-transitory computer-readable medium or a tangible storage medium. By way of example and not limitation, computer-readable media or tangible storage media include random-access memory (RAM), read-only memory (ROM), flash memory, solid-state drive (SSD) and other memory technology, compact disc read-only memory (CD-ROM), digital versatile disc (DVD), Blu-ray (registered trademark) Disc or other optical disk storage, magnetic cassette, magnetic tape, magnetic disk storage, and other magnetic storage devices. The program may be transmitted on a transitory computer-readable medium or a communication medium. By way of example and not limitation, the transitory computer-readable medium or the communication medium includes electrical, optical, acoustic signals, or other form of propagation signals.

Although the present disclosure has been described above by way of the embodiment, the present disclosure is not limited to the above embodiment. Various modifications that would be understood by a person skilled in the art can be made to the configuration and details of the present disclosure within the scope of the present disclosure. Moreover, each embodiment can be combined with other embodiments as appropriate.

What is claimed is:

1. A battery management device, comprising:
a high-frequency signal supplying unit that applies a high-frequency signal with a frequency of 0.1 MHz or higher to a lithium-ion secondary battery;
a storage unit that stores a real part of an alternating current impedance of the lithium-ion secondary battery to which the high-frequency signal is applied at a first point in time, as a reference value for each battery temperature;
an impedance detecting unit that detects the real part of the alternating current impedance of the lithium-ion secondary battery to which the high-frequency signal is applied at a second point in time after the first point in time, at a certain battery temperature; and
a determining unit that determines whether there is deposition of lithium in the lithium-ion secondary battery, based on the real part of the alternating current impedance that is detected and the reference value at the battery temperature.

2. The battery management device according to claim 1, wherein the determining unit determines whether there is deposition of the lithium, based on a difference between the real part of the alternating current impedance that is detected and the reference value.

3. The battery management device according to claim 1, further comprising a generating unit that monitors the battery temperature of the lithium-ion secondary battery at the first point in time and generates information representing the reference value for each battery temperature.

4. The battery management device according to claim 3, wherein
the lithium-ion secondary battery at the first point in time is installed in a vehicle, and
the reference value is detected while the vehicle is traveling or stopped.

5. The battery management device according to claim 1, wherein the lithium-ion secondary battery at the first point in time is a new lithium ion battery.
